(19) United States
(12) Patent Application Publication
(10) Pub. No.: US 2026/0132294 A1
(43) Pub. Date: May 14, 2026

(54) PFAS FREE AQUEOUS COATINGS FOR PAPER PACKAGING

(71) Applicant: MAXIM SPECIALTY CHEMICALS PRIVATE LIMITED, NOIDA (IN)

(72) Inventors: SANJEEV JAIN, NOIDA (IN); MANZIMA JAIN, Noida (IN); VISHISHT JAIN, Noida (IN)

(21) Appl. No.: 19/361,249

(22) Filed: Oct. 17, 2025

(30) Foreign Application Priority Data
Oct. 18, 2024 (IN) 202411079182

(51) Int. Cl. C09D 5/16; B65D 75/52; C09D 4/06; C09D 5/02; C09D 7/45; C09D 7/63; C09D 7/65; C09D 125/14; C09D 133/26; D21H 19/12; D21H 21/16; D21H 27/10

(52) U.S. Cl. CPC C09D 5/1668; B65D 75/52; C09D 4/06; C09D 5/022; C09D 5/027; C09D 7/45; C09D 7/63; C09D 7/65; C09D 125/14; C09D 133/26; D21H 19/12; D21H 21/16; D21H 27/10

(57) ABSTRACT

The present invention relates to the development of sustainable and environment friendly PFAS free aqueous coating composition for paper packaging. More particularly, the present invention relates to PFAS free and water based unique composition for barrier coatings to replace single-use plastics in packaging materials. Barrier coatings disclosed in the present invention enhance the protective properties like heat resistance, moisture resistance, cracking resistance etc. of paper packaging without using any harmful chemical. The present invention further discloses the method of preparing the said coating composition and use of acrylic polymer and bio waxes in making these protective barrier coatings.

### CROSS REFERENCE TO RELATED APPLICATIONS

The present application claims the benefit of priority from Indian Provisional Application No. 202411079182, filed on Oct. 18, 2024, the contents of which are hereby incorporated by reference in their entirety.

### FIELD OF INVENTION

The present disclosure relates to the field of barrier coatings. Particularly, the present invention relates to plastic free barrier coatings. More particularly, the present disclosure relates to per and polyfluoro alkyl substances (PFAS) free aqueous barrier coating composition for paper packaging. Further, the present invention also relates to a process for preparing such barrier coating composition.

### BACKGROUND OF THE INVENTION

Single-use plastics, often known as disposable plastics, are commonly used in packaging, especially food packaging. Food and beverage packaging claims about 60% of plastic packaging. At the end of their use these packaging materials are dumped in uncontrolled sites or littered in the environment. According to recent estimates, 79% of the plastic waste ever produced now sits in landfills, dumps or in the environment, while about 12% has been incinerated and only 9% has been recycled. If current consumption patterns and waste management practices do not improve, by 2050 there will be billions of tons of plastic litter in landfills and the natural environment.

Therefore, there is a need for development and promotion of sustainable alternatives in order to phase out single-use plastics progressively.

Paper and paperboard materials in packaging are becoming increasingly popular and pushing the boundaries of sustainable packaging. However, paper packaging has limitations as it lacks the natural protective properties that plastic provides. To improve the protective properties like moisture resistance, cracking resistance, heat resistance etc. coating technology with paper has been proposed as an additional strategy for accomplishing a more rational use of the materials within the food packaging sector and to minimize the use of single-use plastics. These coatings are often known as barrier coatings.

WO2011014715 A2 discloses fluoropolymer dispersions containing a nonaromatic polyol compound and a method of increasing the shear stability of a fluoropolymer dispersion and method of providing a fluoropolymer composition for coating.

WO2016195893A1 discloses hydrophobic coated paper substrate formed from a paper substrate of paper fibers and internal sizing agent, a surface size layer of one or more surface sizing starches, optionally one or more non-starch hydrophobic surface sizing agents, and optionally one or more paper pigments, on at least one surface of the paper substrate, and at least one hydrophobic pigmented coating layer of a paper pigment component and a hydrophobic pigment binder component on at least one surface size layer.

WO2014186285 relates to coatings and coating compositions that are substantially free of bisphenol A (BPA), which help reduce or minimize flavor loss associated with foods or beverages stored in contact with the coating compositions. The composition includes the reaction products of an intimate mixture of cyclic ether resins and acrylate resins, which provides a cross-linked and interpenetrating network of polymers.

US20070036903A1 relates to Bisphenol F diglycidyl ether (BFDGE) free protective coating compositions for coating metal substrates. The disclosure is also directed to protective coating compositions substantially free of mobile BPA, BPF and aromatic glycidyl ether compounds [e.g. Bisphenol A diglycidyl ether (BADGE), BFDGE and optionally, Novolac glycidyl ether (NOGE).

The disclosure is also directed to methods useful in applying protective coatings to the interior lining of metal containers suitable for contact with foodstuffs. It is further directed to a metal storage container for foodstuffs in which the BPA, BPF, BADGE and BFDGE-free multi-coat protective coating composition is applied to an interior surface of the container.

Therefore, it is known in the prior art that the barrier coatings are used to enhance the protective qualities of these paper-based packets. However, the present technologies are mostly synthetic and contain PFAS and the ones which are aqueous, are not effective to replace plastics in terms of functionality. PFAS in food packaging can be harmful because they can transfer from the packaging into food, leading to human exposure. Concerns about PFAS exposure are linked to potential health problems like immune system dysfunction, increased risk of certain cancers, and liver damage.

Therefore, there is a need for barrier coating composition which are aqueous but still effective in their functionality.

The present invention discloses per and polyfluoro alkyl substances (PFAS) free aqueous barrier coating composition which is harmless and effective in functionality.

The inventors have developed a novel PFAS free aqueous barrier coating for paper packaging based on acrylic copolymer and bio waxes which are biodegradable.

### OBJECTIVES OF THE INVENTION

Accordingly, the present disclosure provides sustainable and environment friendly barrier coating composition for paper packaging which is biodegradable.

One objective of the invention is to develop PFAS free aqueous barrier coating composition for paper packaging.

Yet another objective of the invention is the development of PFAS free and water based unique composition.

Still another objective of the invention is to develop PFAS free aqueous barrier coatings for paper packaging based on acrylic copolymer and bio waxes.

In another aspect the objective of the invention is to develop method of preparing barrier coating composition for paper.

In one of the aspects the coating composition is applied for food and beverages packaging.

In yet another aspect, the present invention discloses that the composition is PFAS free and the coating layer of this composition is applied between 4-20 gsm on dry basis by using various coating methods to achieve target oil, grease and water proofing/resistance values.

In yet another aspect, barrier coatings disclosed in the present invention enhance the protective properties like heat resistance, moisture resistance, cracking resistance etc. of paper packaging without using any harmful chemical.

### DETAILED DESCRIPTION OF INVENTION

While the disclosure is susceptible to various modifications and alternative forms, specific aspects thereof have been shown by way of examples and will be described in detail below. It should be understood, however, that it is not intended to limit the invention to the particular forms disclosed, but on the contrary, the invention is to cover all modifications, equivalents, and alternative falling within the spirit and the scope of the invention.

The use of “including”, “comprising” or “having” and variations thereof herein is meant to encompass the items listed thereafter and equivalents thereof as well as additional items.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those include limits are also included in the disclosure.

The Applicants would like to mention that the studies carried out (below) are to show only those specific details that are pertinent to understanding the aspects of the present disclosure so as not to obscure the disclosure with details that will be readily apparent to those of ordinary skill in the art having benefit of the description herein.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, representative illustrative process and materials are now described.

It is noted that, as used herein and in the appended claims, the singular forms “a”, “an”, and “the” include plural referents unless the context clearly dictates otherwise.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

For convenience, certain terms used in the specification and examples are collected in this section.

Each embodiment is provided by way of explanation of the disclosure and not by way of limitation of the disclosure. For instance, features illustrated or described as part of one embodiment can be applied to another embodiment to yield a still further embodiment. Thus, it is intended that the present disclosure includes such modifications and variations and their equivalents. It is understood by one of ordinary skill in the art that the present disclosure is a description of exemplary embodiments only and is not to be construed as limiting the broader aspects of the present disclosure.

In the present disclosure, the inventors have developed sustainable and environmentally friendly barrier coatings for paper packaging. The barrier coatings disclosed in the present invention are PFAS free aqueous barrier coating composition for paper packaging.

In one of the aspects of present disclosure relates to a barrier coating composition for paper comprising,
(i) Butyl acrylate monomer (BAM) in the range of 15-35 wt. %;
(ii) Styrene monomer in the range of 10-35 wt. %;
(iii) Wax in the range of 5-15%
(iv) Acrylic acid in the range of 1-6 wt. %;
(v) Acrylamide in the range of 1-5 wt. %; and catalyst, surfactant, stabilizer, emulsifier and balance of demineralized water;
   characterized in that the coating composition is devoid of per and polyfluoro alkyl substances and biobased.

In one of the aspects, in the coating composition, butyl acrylate monomer and styrene are present in the ratio of 70:30 to 50:50.

In one of the aspects, in the coating composition, wax is carnauba wax, paraffin wax, bees wax, candelilla wax or polypropylene wax.

In one of the aspects, in the coating composition, catalyst is selected from ammonium per sulfate or potassium per sulfate.

In one of the aspects, in the coating composition, surfactant is anionic surfactant selected from polyether polyols diols, sodium lauryl sulphate (SLS), sodium lauryl ether sulphate or mixture thereof.

In one of the aspects, in the coating composition, stabilizer is 2-(2-Ethoxyethoxy)ethanol.

In one of the aspects, in the coating composition, emulsifier is selected from siloxane, silicone oil or polyether glycol.

In one of the aspects, in the coating composition, having pH in between 7 to 9.

In one of the aspects, in the coating composition, having viscosity in the range of 400-800 cps.

In yet another aspect of the disclosure relates to a method for preparing the barrier coating composition, comprising,
(i) Adding styrene and butyl acrylate monomer under stirring to make a solution at room temperature;
(ii) Adding surfactant and acrylic acid in a separate vessel and increasing the temperature of solution from room temperature to 70-90° C.;
(iii) Adding solution of step (i) along with catalyst in solution of step (ii) in 2-4 hours while maintaining the temperature of 70-90° C.
(iv) Adding wax in the mixture of step (iii) and cooling to 40-45° C.
(v) Adding emulsifier followed by addition of water to obtain the coating composition.

In one of the aspects, the coating composition, as and when applied for food and beverages packaging.

Butyl acrylate monomer (BAM) is a “soft monomer” used in the composition of acrylic copolymers for barrier coatings, contributing essential properties like flexibility, adhesion, and water resistance. The final barrier performance is achieved by copolymerizing BAM with harder monomers. When copolymerized with harder monomers, BAM ensures the final coating can endure expansion and contraction without cracking.

Through copolymerization, BAM properties are combined with those of other monomers to achieve a balanced performance. Butyl acrylate provides strong adhesion to many substrates, ensuring the barrier coating remains securely bonded. This prevents delamination and ensures long-term protection against the elements.

Butyl acrylate-based copolymers offer excellent weather resistance, UV stability, and durability. This is especially important for outdoor applications where the coating is exposed to sunlight and harsh conditions. The butyl side chain is hydrophobic, meaning it repels water. When polymerized, this property helps to create a low-moisture-absorption film that is resistant to water penetration.

Styrene-based barrier coatings are crucial for fast-food wrappers, food containers, and other packaging that requires protection from grease, oil, and moisture. Styrene in a styrene-butyl acrylate composition for barrier coating for paper provides hydrophobicity and durability. The styrene component provides the coating water resistance and toughness, whereas the butyl acrylate monomer contributes to flexibility, making the final film more pliable and ensuring it adheres well to the paper surface. Together, they form a copolymer that improves mechanical strength and water resistance acting as an effective barrier against moisture.

Wax acts as a barrier coating for paper by creating a protective layer that prevents moisture, grease, and oil from penetrating the paper fibers. This makes the paper resistant to staining and leaking, improving durability and shelf life. Wax coatings also enhance the paper's surface by making it smoother and glossier.

Carnauba, paraffin, beeswax, and candelilla wax all serve as effective barrier coatings for paper, with choices depending on factors like cost, performance, and sustainability.

Carnauba wax offers high melting points and excellent water resistance, making it ideal for food packaging. It has very high melting point, strong water resistance, good chemical stability, and biodegradable. It is recognized as a food-grade additive. It is best for high-barrier food packaging where water resistance is crucial.

Paraffin wax provides a consistent and cost-effective option for industrial applications. Paraffin wax exhibit consistent properties, good performance and cost-effective.

Beeswax provides superior water vapor resistance and flexibility. It increases tensile strength and elastic modulus and is flexible.

Candelilla wax is a vegan alternative that is very hard and brittle, often used in combination with other waxes.

Polypropylene wax is a synthetic wax that provides a very effective barrier coating. It provides hard and brittle with a high gloss, making it useful for appearance-sensitive applications.

Acrylic acid (or methacrylic acid) is incorporated to provide properties like adhesion and water dispersibility to the composition.

Acrylamide is added as an additive to improve barrier properties like water resistance and strength.

For catalyst, ammonium persulfate or potassium persulfate are effective polymerization catalysts. Ammonium persulfate is a strong oxidizing agent and applied for polymerization application. Potassium persulfate is initiator for emulsion polymerization, particularly for resins like acrylic and styrene. It shows compatibility with diverse monomers and has ability to create durable films. The selection of catalyst depends on specific reaction conditions and desired properties.

Sodium Lauryl Sulphate (SLS) and Sodium Lauryl Ether Sulphate (SLES) are anionic surfactants used in water-based coating compositions to improve dispersion, stability, and application properties. They ensure that the particles are disperse evenly. This prevents the formation of agglomerates, or clumps, which can lead to coating defects. This stabilization helps maintain the intended color, gloss, and rheology of the final coating. Nonionic surfactant polyether polyols having molecular structure, which contains both hydrophobic (water-repelling) and hydrophilic (water-attracting) components, makes them suitable for stabilizing formulations and improving performance.

2-(2-Ethoxyethoxy)ethanol helps to ensure the stability of the final coating, its primary role is to improve performance characteristics like film formation and appearance. Its chemical structure, which includes both ether and alcohol groups, makes it an effective solvent for resin. This ensures the various components of the coating mixture remain uniformly dispersed.

Emulsifiers based on siloxanes, silicone oils, or polyether glycols is added in the composition. Preferably, polyether-modified siloxanes are class of emulsifier used in coating compositions to incorporate silicone oils into water-based compositions. Polyether-modified siloxanes have a comb-like structure with a hydrophobic siloxane backbone and hydrophilic polyether side chains. This structure allows them to be highly effective emulsifiers.

### EXAMPLES

### Barrier Properties:

For paper packaging, the barrier coatings of the paper play an important role in preserving the freshness of the food product and its shelf life. The main barrier properties that plays crucial role in packaging are moisture vapor transmission rate (MVTR), Oil and Grease resistance (OGR), cobb values and heat sealing.

Moisture Vapor Transmission Rate (MVTR) —It is also known as water vapor transmission rate (WVTR), is a measure of the passage of water vapor through a substance. It is a measure of the permeability of vapor barriers. It is crucial for evaluating materials like packaging to control moisture and protect contents from degradation. Lower MVTR is desired for products sensitive to moisture, like foods, to extend shelf life and stability. Standardized method to measure MVTR, gravimetric (weighing) methods where a dish of water is sealed with the material in a low-humidity environment is used in the present invention.

MVTR generally decreases with increasing thickness of the film/barrier and increases with increasing temperature. Inventors disclosed that the MVTR values at 15 gsm coating layer is being achieved lower than 180 g/m²/24 hrs at 38° C.

Oil and Grease Resistance (OGR) —OGR plays an important role in food packaging to prevent oils and greases from penetrating materials like paper and board. Several methods are used to measure OGR. The KIT method for testing oil and grease resistance in paper follows the TAPPI T559 standard, which uses a series of 12 numbered solutions with varying ratios of castor oil, toluene, and heptane. A drop of each solution is applied to the paper for 15 seconds; the highest numbered solution that does not stain the paper is the kit rating. This rating indicates the paper's resistance to oil, with a higher number signifying greater repellency. The inventors disclosed that the maximum OGR values by KIT method achieved is 12.

Cobb Value—It measures the water absorptiveness (i.e. how much water a material can absorb over a specified time under standard conditions) of paper and other fibers. The cobb value is calculated by measuring the increase in weight due to water absorption. A Cobb value of 1800 refers to the Cobb test duration of 1800 seconds (30 minutes). The Cobb value itself is a measure in grams per square meter (g/m²) of water absorbed by a sample under specific conditions. The 1800-second test period indicates the material's capacity to absorb and retain moisture over a prolonged period, often used to assess water resistance in packaging materials.

Privacy Policy In the present invention, the inventors disclosed that the cobb value with 6 gsm coating layer is lower than 14. A high cobb value indicates high water absorption, while a low cobb value indicates better water resistance.

Heat sealing—It is a process used to join two thermoplastic materials using heat and pressure. It is crucial for ensuring the integrity of food packaging, especially for products that need to be protected from contamination or moisture. The inventors disclosed that a good heat sealing is achieved with the claimed composition at 6-12 gsm coating layers at 120° C. temperature.

However, it is noted that all these above results may vary depending on type of paper substrate and coating methods.

### Example 1

Barrier coating composition was prepared by adding styrene 30 wt. % and butyl acrylate monomer 20 wt. % under stirring to make a solution at room temperature. In a separate vessel, sodium lauryl sulphate and acrylic acid 1 wt. % in a was taken and increasing the temperature of solution from room temperature to 80° C. In this solution, added solution of step styrene and butyl acrylate, along with catalyst in 2-4 hours while maintaining the temperature of 80° C. Now, temperature was decreased to 40° C. and 5 wt. % Carnauba wax was added in this solution. Thereafter, polyether glycol in an amount of 2 wt. % was added followed by addition of water to obtain the coating composition.

### Example 2

The coating composition was prepared using the same method as mentioned in example 1, wherein ratio of styrene and butyl acrylate was in the ratio of 50:50.

### Example 3

The coating composition was prepared using the same method as mentioned in example 1, wherein ratio of styrene and butyl acrylate was in the ratio of 70:30.

### Comparative Example 1

The coating composition was prepared using the same method as mentioned in example 1, wherein ratio of styrene and butyl acrylate was in the ratio of 80:20.

Results are summarized in Table 1 below:

TABLE 1
Barrier Properties at 6 GSM coat weight
on 70 GSM Brown Packaging Paper:

| | | | Water Vapour | |
|---|---|---|---|---|
| | Water | Oil & Grease | Transmission | |
| | Resistance | Resistance- | Resistance | |
| | (Cobb 1800 | OGR (KIT | (WVTR)- | |
| S. No. | seconds) | Value) | G/m²/day | Remark |
| Example 1 | 10 | 10 | 180 | excellent |
| | | | | water |
| | | | | resistance |
| | | | | and MVTR |
| | | | | control. |
| Example 2 | 9 | 12 | 150 | good oil and |
| | | | | grease |
| | | | | resistance, |
| | | | | with a 90% |
| | | | | reduction in |
| | | | | oil |
| | | | | penetration |
| Example 3 | 5 | 12 | 90 | low water |
| | | | | absorption |
| Comparative | 18 | 8 | 200 | — |
| Example 1 | | | | |

*Types of Paper/Substrate: 70 GSM Brown Food Packaging Paper
Coating Technique: Bar Coater
Coat Weight: 6 GSM

Therefore, it can be seen from the inventive example provide the cobb value with 6 gsm coating layer lower than 10, OGR values by KIT method is 12 and the MVTR values is being achieved lower than 180 g/m²/24 hrs. Whereas, comparative example do not meet the desirable results.

### Advantages of Invention

1. The invented materials are PFAS free aqueous barrier coatings for paper packaging.
2. Barrier coatings disclosed in the present invention enhance the protective properties like heat resistance, moisture resistance, cracking resistance etc. of paper coating without using any harmful chemical.
3. The invention would significantly benefit the environment as the intent is to eliminate the single use plastic for food packaging.

We claim:

1. A coating composition for paper comprising,
(i) Butyl acrylate monomer (BAM) in the range of 15-35 wt. %;
(ii) Styrene monomer in the range of 10-35 wt. %;
(iii) Wax in the range of 5-15%
(iv) Acrylic acid in the range of 1-6 wt. %;
(v) Acrylamide in the range of 1-5 wt. %; and catalyst, surfactant, stabilizer, emulsifier and balance of demineralized water;
characterized in that the coating composition is devoid of per and polyfluoro alkyl substances and biobased.

2. The coating composition as claimed in claim 1, wherein butyl acrylate monomer and styrene are present in the ratio of 70:30 to 50:50.

3. The coating composition as claimed in claim 1, wherein wax is carnauba wax, paraffin wax, bees wax, candelilla wax or polypropylene wax.

4. The coating composition as claimed in claim 1, wherein catalyst is selected from ammonium per sulfate or potassium per sulfate.

5. The coating composition as claimed in claim 1, wherein surfactant is anionic surfactant selected from polyether polyols diols, Sodium lauryl sulphate (SLS), Sodium lauryl ether sulphate or mixture thereof.

6. The coating composition as claimed in claim 1, wherein stabilizer is 2-(2-Ethoxyethoxy)ethanol.

7. The coating composition as claimed in claim 1, wherein emulsifier is selected from siloxane, silicone oil or polyether glycol.

8. The coating composition as claimed in claim 1 having pH in between 7 to 9.

9. The coating composition as claimed in claim 1 having viscosity in the range of 400-800 cps.

10. A method for preparing the coating composition as claimed in claim 1, comprising,
(i) Adding styrene and butyl acrylate monomer under stirring to make a solution at room temperature;
(ii) Adding surfactant and acrylic acid in a separate vessel and increasing the temperature of solution from room temperature to 70-90° C.;
(iii) Adding solution of step (i) along with catalyst in solution of step (ii) in 2-4 hours while maintaining the temperature of 70-90° C.
(iv) Adding wax in the mixture of step (iii) and cooling to 40-45° C.
(v) Adding emulsifier followed by addition of water to obtain the coating composition.

11. A food and beverage packing comprising the coating composition of claim 1.
